(19) United States
(12) Patent Application Publication
(10) Pub. No.: US 2014/0019549 A1
(43) Pub. Date: Jan. 16, 2014

(54) Control System for Conferencing Applications in Named-Data Networks

(71) Applicant: Futurewei Technologies, Inc., Plano, TX (US)

(72) Inventor: Jun Wei, San Jose, CA (US)

(21) Appl. No.: 13/943,230

(22) Filed: Jul. 16, 2013

Related U.S. Application Data
(60) Provisional application No. 61/671,943, filed on Jul. 16, 2012.

(51) Int. Cl. H04L 29/06

(52) U.S. Cl. CPC H04L 65/403
USPC 709/204

(57) ABSTRACT

A conference control server comprising a plurality of first ports configured to couple to a plurality of first control links, wherein the first control links connect the conference control server to a plurality of other conference control servers in a server cluster, a plurality of second ports configured to couple to a plurality of second control links, wherein the second control links connect the conference control server to a plurality of conference participating clients, and a processor coupled to the first ports and the second ports, wherein the processor is configured to register with a conference control system, wherein the conference control server is ready to serve a conference once registered, provide conference control and management functions to the conference participating clients and the other conference control servers, join the server cluster at any time, leave the server cluster without restrictions, and serve the conference participating clients.

### CROSS-REFERENCE TO RELATED APPLICATIONS

The present application claims priority to U.S. Provisional Patent Application 61/671,943, filed Jul. 16, 2012 by Jun Wei, and entitled “Control System for Conferencing Applications in Named-Data Networks”, which is incorporated herein by reference as if reproduced in its entire.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Conferencing application systems facilitate and conduct conferences in real time between two or more participants at different sites by using computer networks to transmit audio, video, and/or text data. Conferencing application systems may handle media data exchanges between conference participants and perform conference control and management functions. Conference control and management functions may include conference admission (e.g. registration), floor control (e.g. moderation), and updates (e.g. agenda). One of the major challenges in conferencing application systems is control and management of the conference participants. In current Internet Protocol (IP) network architecture, IP multicast may be used to support the one-to-many communication nature of conference applications. In practice, multicast services may be difficult to realize and are mostly limited to research. As such, many conferencing application systems may rely on a centralized server for conference controls, managements, and media exchange. That is, a central server may be used to control and manage the conference, process data from participants, and then redistribute the data back to the participants. The design with a single centralized server may lead to traffic concentration at the server and make applications vulnerable to single point of failure, and may also be non-scalable. In practice, there are a limited number of participants that may be supported in such conference applications.

Recently, a Name Data Network (NDN) has been proposed as a new Internet architecture to address the data centric usage of today's network. In the NDN, data or content is addressed by its name instead of referencing to a specific physical location where the data is stored as in the traditional IP networks. NDN is a receiver driven, data centric communication protocol. NDN transforms data access from a push-based model to a pull-based model. The embedded caching mechanism and multicast support in NDN also translates to a more efficient and faster service or data distribution. Consequently, a control system for conferencing applications may be designed for NDN, leveraging NDN's architecture to provide a more robust, scalable, and efficient system for conference applications.

### SUMMARY

In one embodiment, the disclosure includes a conference control server comprising a plurality of first ports configured to couple to a plurality of first control links, wherein the first control links connect the conference control server to a plurality of other conference control servers in a server cluster, a plurality of second ports configured to couple to a plurality of second control links, wherein the second control links connect the conference control server to a plurality of conference participating clients, and a processor coupled to the first ports and the second ports, wherein the processor is configured to register with a conference control system, wherein the conference control server is ready to serve a conference once registered, provide conference control and management functions to the conference participating clients and the other conference control servers, join the server cluster at any time, leave the server cluster without restrictions, and serve the conference participating clients, wherein a relationship between the conference control server and each of the conference participating client is non-binding, and wherein the conference control server is nearer to the served conference participating clients than the other conference control servers in the server cluster.

In another embodiment, the disclosure includes a conference participating client comprising a plurality of first ports configured to couple to a plurality of control links, wherein the control links connect the conference participating client to a plurality of conference control servers in a server cluster, a plurality of second ports configured to couple to a plurality of media links, wherein the media links connect the conference participating client to a plurality of other conference participating clients, and a processor coupled to the first ports and the second ports, wherein the processor is configured to send a conference creation request, receive a conference creation response from a first conference control server, receive a conference service from the first conference control server, wherein the conference participating client is not bound to the first conference control server, and receive the conference service from another conference control server in the cluster freely.

In another embodiment, the disclosure includes a method for building a control system for conferencing applications in a Named Data Network (NDN), comprising configuring a group of control servers in the NDN, wherein the control servers communicate via control links, and wherein the control servers provide conference control and management functions to conferencing clients with no fixed membership binding, receiving a conference registration request from a first conference client, wherein the first conference client is a conference organizer, forming a server cluster when a first control server responds to the conference registration, wherein the first control server is one of the control servers in the group, establishing a first control link in a control plane between the first control server and the conference organizer, receiving a conference registration from a new conference client, establishing a second control link in the control plane between the first control server and the new conference client, receiving a cluster join request from a second control server, wherein the cluster join request is prompted by a new conference client registration, and wherein the second control server is closer to the new conference client than the first control server, pulling conference information from the first control server to the second control server, and replacing the first control server in the second link by the second control server.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic system of an embodiment for a control system for conferencing applications in Named Data Networks (NDNs).

FIG. 2 is a protocol diagram of an embodiment of a conference message exchange method in NDNs.

FIG. 3 is a protocol diagram of another embodiment of a conference message exchange method in NDNs.

FIG. 4 is a protocol diagram of an embodiment of a server cluster creation method in NDNs.

FIG. 5 is a protocol diagram of an embodiment of a server cluster expansion method and a participating client handover method in NDNs.

FIG. 6 is a protocol diagram of an embodiment of a conference control server failure and recovery method in NDNs.

FIG. 7 is a schematic diagram of an embodiment of a control system for multiple conferences in a NDN.

FIG. 8 is a schematic diagram of an embodiment of a network element.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Currently, many conferencing application systems are designed with a centralized server to handle conference control and management, as well as media data exchange. The drawbacks of a centralized server include a single point of failure, server overflow, and a lack of scalability. To improve the performance of a centralized server, a server cluster approach with a designated group of servers may be used. However, membership management between participants and servers may be complex. For instance, the assignment or re-assignment of a participant to a particular server may need to be managed and tracked when the server fails and/or recovers. Thus, the server cluster approach may not be robust. Another solution may be a server-less approach in the form of a free conference by using Internet Protocol (IP) multicast, but this may be difficult to realize. Consequently, a hybrid approach with a cluster server-based control plane and a server-less media plane may be promising.

Many of today's applications are content-centric, such as conferencing applications. A traditional connection-oriented communication model in current IP network may not be suitable. Thus, a Content-Centric Networking (CCN) architecture has been proposed recently to change the communication model from connection-oriented to content-oriented. NDN is a NSF program to facilitate research efforts on content-centric network (CCN). NDN uses a pull-based communication model with two primitives, namely interest and data, and one interest packet may pull one data packet. Each packet is identified by a name. An example of the name prefix may be a Universal Resource Locator (URL)-like format (e.g. /ccn/myinterest). A NDN router may include a Content Store (CS), a Pending Interest Table (PIT), and a Forwarding Information Base (FIB). The router may cache a data packet in the CS for later retrieval. The PIT may aggregate multiple interest packets with the same prefix and may forward only one interest packet for each name prefix. The PIT may also remember the interfaces where those interest packets are from for later use. An interest packet is routed by its name, based on the FIB entries. Once a matched data packet is found, either from the original source or from a cached copy in a NDN router, the NDN router may traverse the reverse path of the interest packet. To forward a data packet, a NDN router may check with PIT entries against the name prefix of the data packet, and may forward one copy towards each face that has a pending interest. The CS may allow caching inside NDN networks and the PIT enables native multicast distribution. As such, the inherent caching and multicast distributing properties in NDN may provide better support for conferencing application systems designed natively for NDN than for IP networks. Some research had been conducted for conference applications in NDN, but mostly limited to conference and speaker discoveries only. Hence, there is a need to design a control system for conference applications in NDNs that may better utilize the NDN architecture.

Disclosed herein is a method, apparatus, and system for building a control system for conferencing applications in NDNs. The disclosed embodiments may combine a participant-driven and distributed server-based approach for conference control and management and a server-less approach for conference media forwarding among participants. The disclosed embodiments may exchange conference messages in the form of NDN primitives, interest and data. The disclosed system may leverage the caching and multicast support in NDN. In an embodiment, a pool of control servers in NDN may be ready to facilitate conferences, a conference may be initiated by a conference organizer sending an interest packet, a control server from the pool may respond and serve the requested conference. In another embodiment, a cluster may grow when a non-cluster control server sees a conference join request from a participant who is close by and the non-cluster control server may request to join the cluster. In another embodiment, the control servers in a cluster may join or leave the server cluster freely without interfering with the control and management functions. The server cluster may grow or shrink with the footprint of the participating users and scale dynamically to accommodate any number of participants. In another embodiment, a participant may communicate freely among control servers in the cluster. In another embodiment, multiple independent clusters in a control system may serve multiple independent conferences simultaneously.

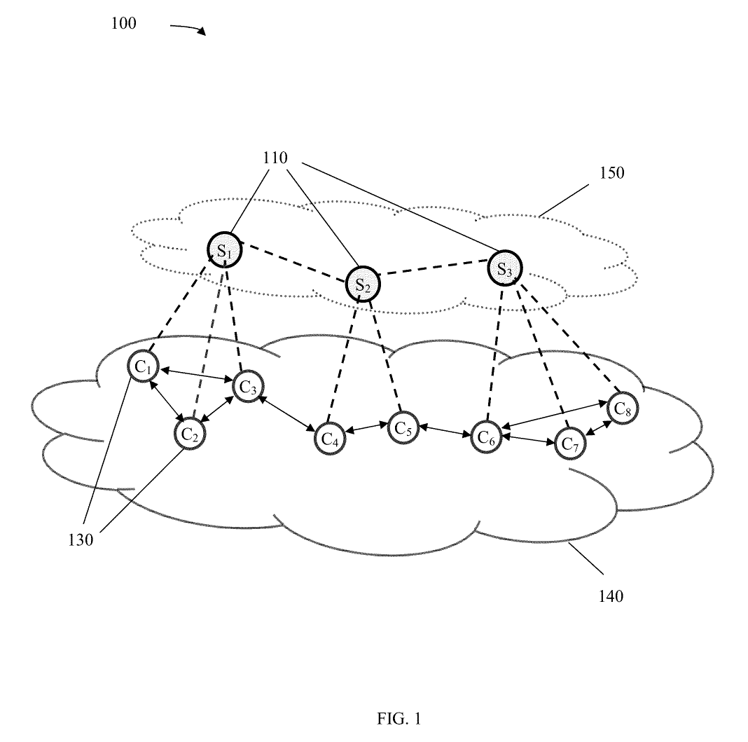

FIG. 1 is a conferencing application control system 100 in NDN. In system 100, media traffic or media plane is assumed to be separated from control traffic or control plane. The system 100 comprises a plurality of control servers 110 (S₁, S₂ and S₃) in a control plane 150 and a plurality of participating clients 130 (C₁ to C₈) in a media plane 140. The control servers 110 may communicate to each other and the participating clients 130 via control channels, which are represented by dashed lines. The participating clients 130 may communicate with other participating clients 130 in the media plane 140 using media channels, which are represented by solid lines. The control channels and media channels may be separate physical connections (different links) or may be virtually separated within the same physical connection (e.g. Virtual Local Area Networks (VLANs) within a link). The control servers 110 may facilitate conference control and management functions through message exchanges with participating clients 130. An example of a control server is, but not limited to, an Extensible Messaging and Presence Protocol (XMPP) server with Multi-User Chat (MUC) extensions.

The conference control and management functions may be divided into basic functions and specific functions. The basic functions may include disseminating conference agenda and updates from the organizer to the participating clients 130. In NDNs, such operations may cause a large number of interests from participating clients 130 to pull common information from the control server. Thus, the server cluster approach may alleviate the traffic congestion or failure at a single control server. The specific controls may include conference admission (e.g. registration) and floor control (e.g. moderation). In addition, a server may need to get authorization from the conference organizer during a registration and to synchronize information on registered participating clients 130 with the conference organizer.

The interactions between a conference organizer and a control server may begin when a conference organizer requests to create a conference and submits a conference agenda. During the conference, the conference organizer may submit conference updates. The interactions between a participating client 130 and a control server 110 may begin when a participating client 130 joins a conference where the participating client 130 may query conference list, request conference registration, and request conference agenda. During a conference, participating clients 130 may also query announcement and/or request updates. At the end of a conference, participating clients 130 may submit feedback. An example of floor control is a question and answer (Q&A) session. In a Q&A session, a moderator may grant permissions and facilitate the order of speakers.

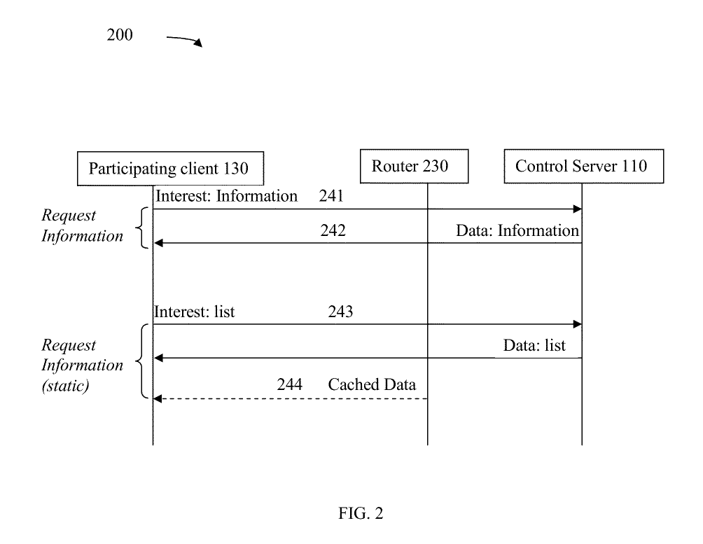

In general, conference control operations may comprise two types of message exchanges, participating client request and a participating client submission. In a NDN, the message exchange uses two NDN primitives: an interest and a data. To retrieve data, a consumer may send an interest primitive with a name for the desired data. Then, the provider may respond with a data primitive that carries the name and the actual data. FIG. 2 is a protocol diagram of a method 200 for a participating client 130 to request data from a control server 110 in a NDN. The request may be a conference agenda, or an update, or a Q&A list. The method 200 may begin with a conference name defined as conf_service in progress. At step 241, the participating client 130 may first issue an interest with the conference name prefix (e.g. conf_service/conf_information). The interest may be routed to the control server 110. At step 242, the control server 110 may respond with a data packet of the same name. Alternatively, a nearby router 230, who may have cached the requested data, may send the cached data to the participating client 130 as shown in steps 243 and 244. The NDN caching property may also reduce server load because most of the interest may not even reach the control server. In addition, PIT may aggregate interests with the same name prefix from different interfaces and only forward one interest to the control server, which may reduce both server load and traffic concentration in the network.

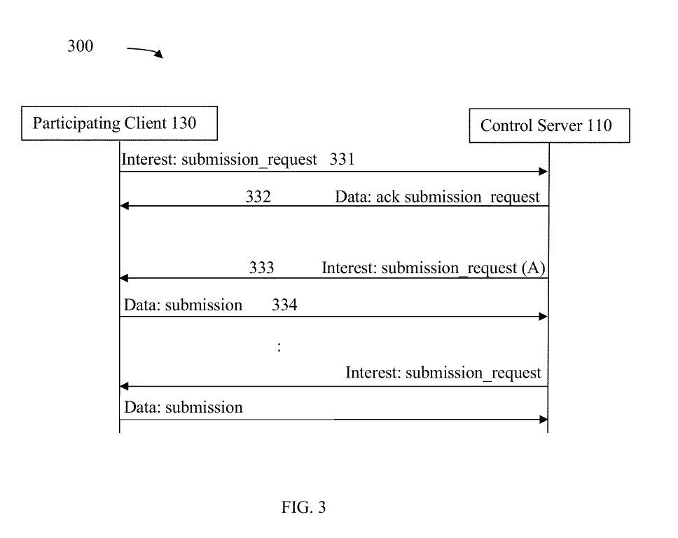

FIG. 3 is a protocol diagram of a method 300 for a participating client 130 to submit data to a control server 110 in a NDN. A participating client 130 submission usually may require two steps since data is driven by the receiver. First, the participating client 130 may request for submission by issuing an interest to the control server 110 such that the control server 110 may issue an interest to pull the data from the participating client 130 afterwards. For instance, at step 331 the participating client 130 may send an interest to the control server 110 to indicate the desire to submit data. At step 332, the control server 110 may acknowledge the submission interest. At step 333, the control server 110 may send an interest to the participating client 130 to request the participating client 130 to submit data. At step 334, the participating client 130 may send the submission data to the control server 110. Steps 333 and 334 may be repeated until all the submissions are completed.

In some embodiments, a conferencing control system may comprise a group of control servers that may be used to facilitate conferences. Each conference may request a server cluster from the control system. A common communication channel is assumed for the control system. In NDNs, this may be a name identifying the control system. A cluster may be formed when a conference organizer initiates a conference by registering with a control server. The control server that handles the conference registration may become the first server of the server cluster. A non-cluster server may also be triggered to join the cluster when a nearby participating client 130 joins the conference. This process may continue and the cluster may expand as more participating clients 130 join the conference.

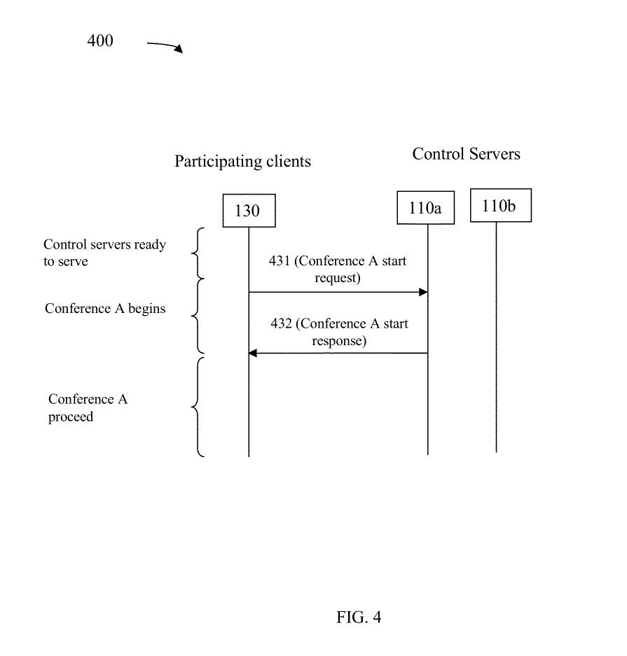

FIG. 4 is a protocol diagram of a method 400 creating a first control server 110a in a server cluster in NDNs, which may be implemented between a participating client 130 and a plurality of control servers 110a and 110b. Method 400 may begin with a pool of inactive control servers 110a and 110b ready to facilitate conferences which are also known to the network. At step 431, a participating client 130, who is the conference organizer, may request to start a conference A. At step 432, a control server 110a, who is ready and willing to serve the conference, may respond and become the first control server in the server cluster serving conference A. Note that the control server 110a may be an arbitrary control server in the conferencing control system. In the case where a control server 110a may be overloaded or busy, control server 110a may ignore the conference creation request, and instead control server 110b may answer the conference creation request. Note that the protocol diagram in FIG. 4 is for illustration purpose and there may be multiple transactions of interests and data involved in practice.

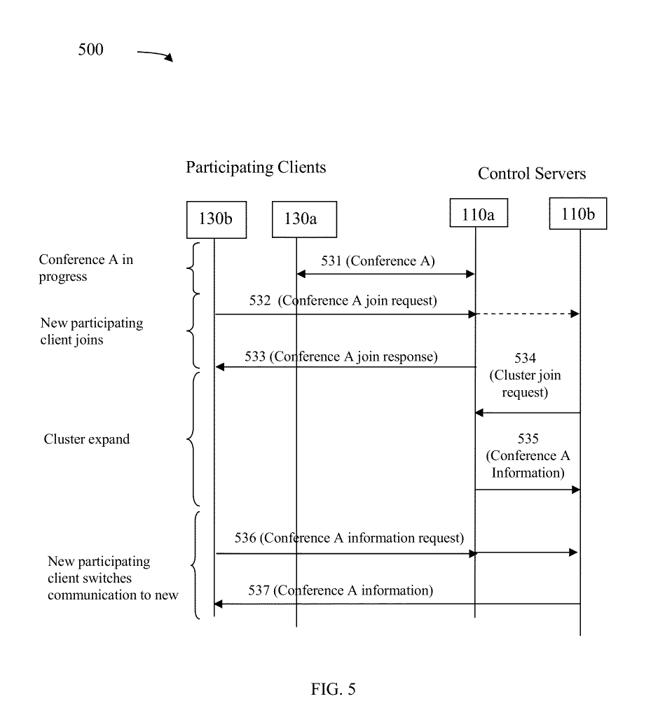

FIG. 5 is a protocol diagram of a method 500 of server cluster expansion and participating client handover in NDNs, which may be implemented between participating clients 130a, 130b and control servers 110a, 110b. Method 500 may begin with a server cluster with one active control server 110a serving conference A to participating client 130 as shown in step 531. At step 532, a new participating client 130b may send a request to join conference A. At step 533, the control server 110a may respond to the conference join request. A second control server 110b, who is available and nearest to the new participating client 130b, where nearest may be in terms of closest in proximity or reach with fewest hops, may have seen or been notified of the conference join request. This may trigger the control server 110b to send a cluster join request to the control server 110a as shown in step 534. At step 535, the control server 110a may respond to the control server 110b by sending conference A information. At this point, the server cluster has two control servers, namely 110a and 110b, serving conference A. At step 536, the participating client 130b may request for information. The control server 110b, who is closer to participating client 130b, may start to communicate with the new participating client 130b as shown in step 537. The new participating client 130b may handover all subsequent communications to the control server 110b. This may be an automatic process in NDNs where interactions may always be from a nearest available router. This server cluster may continue to grow as more participating clients join the conference. As a result, nearby inactive control servers who are ready and willing to serve may join the cluster. Alternatively, the server cluster may shrink as participating clients leave the conference, which may cause some active control servers who are no longer needed to leave the cluster. In this embodiment, there is no pre-assigned control server in this process and any control servers in the control system may request to join the cluster. The control servers in the cluster may also join and leave freely without interfering the conference since there is no membership binding. In addition, the protocol diagram in FIG. 5 is for illustration purpose and there may be multiple transactions of interests and data involved in practice.

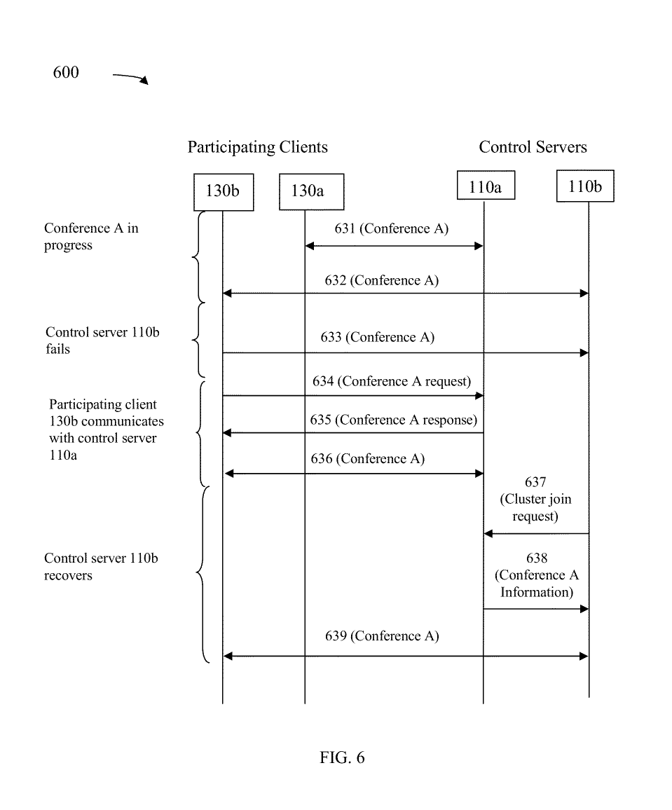

FIG. 6 is a protocol diagram of a method 600 of control server failure and recovery in NDNs, which may be implemented between participating clients 130a, 130b and control servers 110a, 110b. Method 600 may begin with a server cluster comprising two control servers, 110a and 110b serving conference A as shown in step 631 and step 632, where a participating client 130a and a participating client 130b are communicating with the control servers 110a and 110b, respectively. At step 633, the participating client 130b may continue to communicate with the control server 110b, but the control server 110b may fail to respond due to internal failure or server overload. At step 634, the participating client 130b may request for conference A again. At step 635, the control server 110a may respond to the participating client 130b. At step 636, the participating client 130b may re-establish the communication with the control server 110a. After some time, the control server 110b may be restored and may repeat the cluster join request as shown in step 637. At step 638, the control server 110a may send conference A information to the control server 110b similar to the previous cluster join process. At step 639, the participating client 130b may switch its communication from the control server 110a to the control server 110b since the control server 110b is closer. As shown in method 600, participating client 130b may communicate with server 110b at an initial time and may interact with another server 110a at a later time. Thus, the disclosed control system is also self-organized and self-restored by leveraging NDNs architecture.

The server cluster in the disclosed system may be loosely structured with no membership or fixed binding with participating clients. The cluster may change dynamically based on demands. The cluster coverage may grow or shrink with the footprint of the participating clients as participating clients join or leave the conference, respectively. In a NDN, a participating client may usually be routed to the nearest available cluster server. As such, the disclosed system may provide robust and efficient server-based control and management that is resilient to single point of failure with elastic scalability.

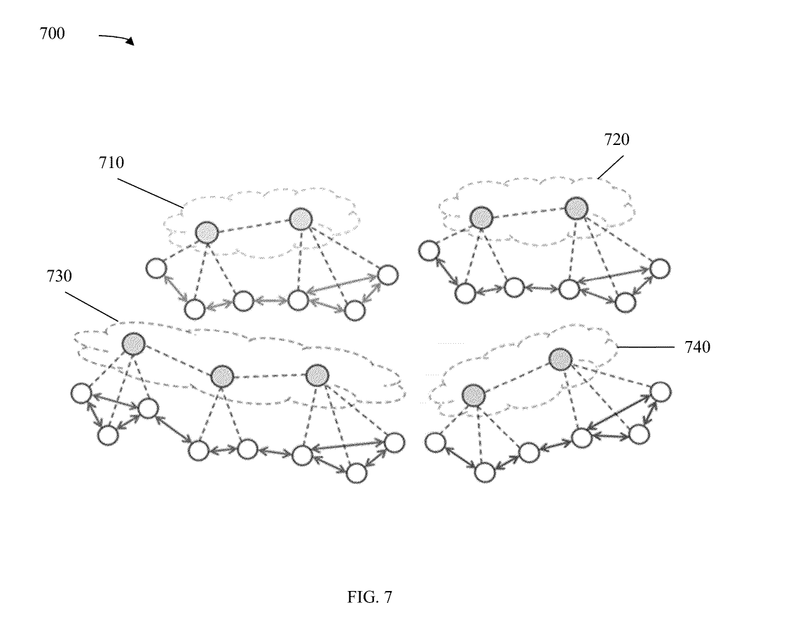

The disclosed system may also support multiple conferences as shown in FIG. 7. The control system 700 is an example of a control system serving multiple conferences. In system 700, there are four server clusters 710, 720, 730, and 740, each serving a different conference. The four server clusters are operating independently without knowing the presence of each other.

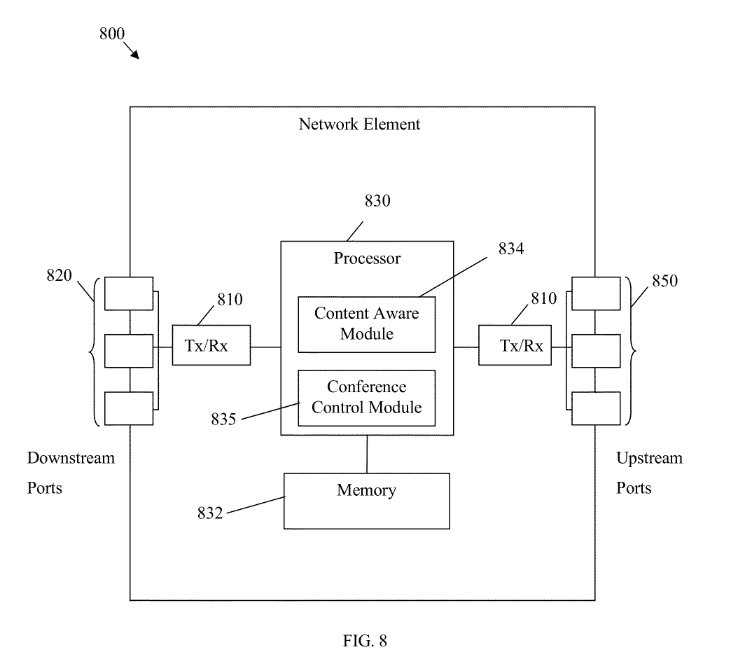

FIG. 8 is a schematic diagram of an embodiment of a Network Element (NE) 800 within a NDN, which may be a control server 110 that provides conference control and management functions to conferencing clients 130. In some embodiments NE 800 may also act as other node(s) in the NDN. Person of ordinary skill in the art will be aware that participating client 130 will be similarly configured. One skilled in the art will recognize that the term NE encompasses a broad range of devices of which NE 800 is merely an example. NE 800 is included for purposes of clarity of discussion, but is in no way meant to limit the application of the present disclosure to a particular NE embodiment or class of NE embodiments. At least some of the features/methods described in the disclosure may be implemented in a network apparatus or component such as a NE 800. For instance, the features/methods in the disclosure may be implemented using hardware, firmware, and/or software installed to run on hardware. The NE 800 may be any device that transports frames through a network, e.g., a switch, router, bridge, server, a client, etc. As shown in FIG. 8, the NE 800 may comprise transceivers (Tx/Rx) 810, which may be transmitters, receivers, or combinations thereof. A Tx/Rx 810 may be coupled to plurality of downstream ports 820 for transmitting and/or receiving frames from other nodes and a Tx/Rx 810 may be coupled to plurality of upstream ports 850 for transmitting and/or receiving frames from other nodes, respectively. A processor 830 may be coupled to the Tx/Rx 810 to process the frames and/or determine which nodes to send frames to. The processor 830 may comprise one or more multi-core processors and/or memory devices 832, which may function as data stores, buffers, etc. Processor 830 may be implemented as a general processor or may be part of one or more application specific integrated circuits (ASICs) and/or digital signal processors (DSPs). Processor 830 may comprise a content aware module 834, which may provision content forwarding, content caching and interest processing in NDN as discussed above. Processor 830 may also comprise a conference control module 835, which may provide conference control and management functions, such as conference message exchange described in methods 200 and 300, conference creation method described in method 400, server cluster expansion method described in method 500 and control server failure and recovery method described in method 600. In an alternative embodiment, the content aware module 834 and/or conference control module 835 may be implemented as instructions stored in memory 832, which may be executed by processor 830. The memory module 832 may comprise a cache for temporarily storing content, e.g., a Random Access Memory (RAM). Additionally, the memory module 832 may comprise a long-term storage for storing content relatively longer, e.g., a Read Only Memory (ROM). For instance, the cache and the long-term storage may include dynamic random access memories (DRAMs), solid-state drives (SSDs), hard disks, or combinations thereof.

It is understood that by programming and/or loading executable instructions onto the NE 800, at least one of the processor 830, the cache, and the long-term storage are changed, transforming the NE 800 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit (ASIC) that hardwires the instructions of the software. In the same manner as a machine controlled by a new ASIC is a particular machine or apparatus, likewise a computer that has been programmed and/or loaded with executable instructions may be viewed as a particular machine or apparatus.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. All documents described herein are incorporated herein by reference.

What is claimed is:

1. A conference control server comprising:
a plurality of first ports configured to couple to a plurality of first control links, wherein the first control links connect the conference control server to a plurality of other conference control servers in a server cluster;
a plurality of second ports configured to couple to a plurality of second control links, wherein the second control links connect the conference control server to a plurality of conference participating clients; and
a processor coupled to the first ports and the second ports, wherein the processor is configured to:
register with a conference control system, wherein the conference control server is ready to serve a conference once registered;
provide conference control and management functions to the conference participating clients and the other conference control servers;
join the server cluster at any time;
leave the server cluster without restrictions; and
serve the conference participating clients, wherein a relationship between the conference control server and each of the conference participating clients is non-binding, and wherein the conference control server is nearer to the served conference participating clients than the other conference control servers in the server cluster.

2. The conference control server of claim 1, wherein the conference control and management functions comprise at least one of distributing a conference agenda, providing updates to the conference participating clients, managing a registrant list, and managing a floor control.

3. The conference control server of claim 1, wherein the server cluster is serving a conference, and wherein the server cluster scales dynamically based on the need to support the conference participating clients.

4. The conference control server of claim 1, wherein the conference control server is nearer to the served conference participating clients than the other conference control servers in the server cluster based on the proximity of the conference control server to the served conference participating clients.

5. The conference control server of claim 1, wherein the conference control server is nearer to the served conference participating clients than the other conference control servers in the server cluster based on the fewest number of hops between the served conference participating clients and the conference control server.

6. The conference control server of claim 1, wherein the processor is further configured to:
receive a conference creation request from a first conference participating client, wherein the first conference participating client is a conference organizer;
create the conference, wherein the conference control server is a first control server in the server cluster;
send a conference creation response to the conference organizer; and
serve the first conference participating client.

7. The conference control server of claim 1, wherein the conference control server is not serving the conference, and wherein the processor is further configured to:
detect a conference join request from a new conference participating client;
detect a conference join response from a first conference control server, wherein the first conference control server is serving the conference;
send a cluster join request to the first conference control server, wherein the conference control server is nearer to the new conference participating client than the first conference control server;
receive conference information from the first conference control server; and
serve the new conference participating client.

8. The conference control server of claim 1, wherein the conference control server is serving a conference, and wherein the processor is further configured to:
receive a conference join request from a new conference participating client;
send a conference join response to the new conference participating client;
serve the new conference participating client;
receive a cluster join request from a second conference control server in the conference control system, wherein the second conference control server is nearer to the new conference participating client than the conference control server;
send conference information to the second conference control server; and
stop serving the new conference participating client when the second conference control server starts serving the new conference participating client.

9. The conference control server of claim 1, wherein the conference control server is serving a new conference participating client in the conference, and wherein the processor is further configured to:
stop serving the new conference participating client when the conference control server is overloaded;
recover from the overload condition;
send a cluster join request to a first conference control server in the server cluster, wherein the conference control server is nearer to the new conference participating client than the first conference control server;
receive conference information from the first conference control server; and
resume serving the new conference participating client.

10. The conference control server of claim 1, wherein the conference control server is serving a new conference participating client in the conference, and wherein the processor is further configured to:
stop serving the new conference participating client when the conference control server is failed;
recover from the failure condition;
send a cluster join request to a first conference control server in the server cluster, wherein the conference control server is nearer to the new conference participating client than the first conference control server;
receive conference information from the first conference control server; and
resume serving the new conference participating client.

11. The conference control server of claim 1, wherein the conference control server operates in a Named Data Network (NDN), and wherein the server cluster is identified by a name in the NDN.

12. The conference control server of claim 1, wherein the conference control system comprises multiple server clusters, wherein each server cluster serves a different conference, and wherein the server clusters are independent of each other.

13. A conference participating client comprising:
a plurality of first ports configured to couple to a plurality of control links, wherein the control links connect the conference participating client to a plurality of conference control servers in a server cluster;
a plurality of second ports configured to couple to a plurality of media links, wherein the media links connect the conference participating client to a plurality of other conference participating clients; and
a processor coupled to the first ports and the second ports, wherein the processor is configured to:
send a conference creation request;
receive a conference creation response from a first conference control server;
receive a conference service from the first conference control server, wherein the conference participating client is not bound to the first conference control server; and
receive the conference service from another conference control server in the cluster freely.

14. The conference participating client of claim 13, wherein the processor is further configured to:
send a conference join request;
receive a conference join response from the first conference control server;
receive the conference service from the first conference control server;
stop receiving the conference service from the first conference control server when a second conference control server joins the server cluster, wherein the second conference control server is nearer to the conference participating client than the first conference control server; and
receive the conference service from the second conference control server.

15. The conference participating client of claim 13, wherein the conference participating client is participating in the conference, wherein the processor is further configured to:
receive the conference service from the first conference control server;
stop receiving the conference service from the first conference control server when the first conference control server is overloaded;
receive the conference service from a second conference control server, wherein the second conference control server belongs to the server cluster serving the conference;
stop receiving the conference service from the second conference control server when the first conference control server recovers from the overload condition, wherein the first conference control server is nearer to the conference participating client than the second conference control server; and
receive the conference service from the first conference control server.

16. The conference participating client of claim 13, wherein the conference participating client is participating in the conference, wherein the processor is further configured to:
receive the conference service from the first conference control server;
stop receiving the conference service from the first conference control server when the first conference control server fails;
receive the conference service from a second conference control server, wherein the second conference control server belongs to the server cluster serving the conference;
stop receiving the conference service from the second conference control server when the first conference control server recovers from failure, wherein the first conference control server is nearer to the conference participating client than the second conference control server; and
receive the conference service from the first conference control server.

17. A method for building a control system for conferencing applications in a Named Data Network (NDN), comprising:
configuring a group of control servers in the NDN, wherein the control servers communicate via control links, and wherein the control servers provide conference control and management functions to conferencing clients with no fixed membership binding;
receiving a conference registration request from a first conference client, wherein the first conference client is a conference organizer;
forming a server cluster when a first control server responds to the conference registration, wherein the first control server is one of the control servers in the group;
establishing a first control link in a control plane between the first control server and the conference organizer;
receiving a conference registration from a new conference client;
establishing a second control link in the control plane between the first control server and the new conference client;
receiving a cluster join request from a second control server, wherein the cluster join request is prompted by a new conference client registration, and wherein the second control server is closer to the new conference client than the first control server;
pulling conference information from the first control server to the second control server; and
replacing the first control server in the second link by the second control server.

18. The method of claim 17, wherein the conference control and management functions comprise at least one of distributing a conference agenda, providing updates to a conference participating client, managing a registrant list, and managing a floor control.

19. The method of claim 17, further comprising:
replacing the second control server in the second control link with the first control server when the second control server is overloaded;
subsequently replacing the first control server in the second control link with the second control server when the second control server is not overloaded;
replacing the second control server in the second control link with the first control server when the second control server fails; and
subsequently replacing the first control server in the second control link with the second control server when the second control server is restored.

20. The method of claim 17, further comprising:
receiving multiple conference creation requests from multiple conference organizers;
forming multiple server clusters when each of the conference creation request is responded by a new control server; and
facilitating the multiple conferences by the multiple server clusters independently.
